(19) United States
(12) Patent Application Publication
(10) Pub. No.: US 2009/0029102 A1
(43) Pub. Date: Jan. 29, 2009

(54) Composite structure with decorative surface

(75) Inventors: David B. McCulloch, Southgate, MI (US); Edward T. Kuczynski, Allen Park, MI (US); Paul V. Farkas, Willowdale (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: Woodbridge Foam Corporation

(21) Appl. No.: 10/611,434

(22) Filed: Jul. 2, 2003

Related U.S. Application Data
(60) Provisional application No. 60/392,933, filed on Jul. 2, 2002.

(51) Int. Cl. B32B 5/12; B29C 70/68

(52) U.S. Cl. 428/114; 264/258

(57) ABSTRACT

A composite structure comprising a core portion having a pair of generally opposed surfaces. A first fibrous layer is disposed on a first surface of the core portion and has a plurality of fibres disposed substantially parallel to the first surface. A second fibrous layer disposed on a second surface of the core portion and has a plurality of fibres disposed substantially parallel to the second surface. A first polymer layer is disposed over the first fibrous layer and a second polymer layer is disposed over the second fibrous layer. The first fibrous layer is partially embedded in both the core portion and the first polymer layer. The second fibrous layer is partially embedded in the core portion and the second polymer layer. The present composite structure may be used in structural and/or non-resilient components of the vehicle. Such components include exterior body panels (e.g., TONNEAU covers), door panels, beds for pickup trucks and the like. A process for producing the present composite structure is also described.

### CROSS-REFERENCE TO RELATED APPLICATION

The present application claims the benefit under 35 U.S.C. § 119(e) of provisional patent application Ser. No. 60/392,933, filed Jul. 2, 2002, the contents of which are hereby incorporated by reference.

### BACKGROUND OF THE INVENTION

1. Field of the Invention

In one of its aspects, the present invention relates to a composite structure. In another of its aspects, the present invention relates to a process for production of a composite structure.

2. Description of the Prior Art

In recent years, automotive manufacturers have relied more on non-metal components for finishing of vehicle interiors and exteriors. Thus, it is now conventional to use material such as plastics, foam and the like as interior trim parts in vehicles. Further, reaction injection molded (RIM) and reinforced reaction injected molded (RRIM) parts are used in exterior components (e.g., bumper covers) of vehicles.

The advantages of these alternate materials include relatively low cost production, reduced weight (leading to improved fuel efficiency for the vehicle) and the like.

One area which has received some attention is the use of alternate materials for structural and/or non-resilient components of the vehicle. Such components include exterior body panels (e.g., TONNEAU covers), door panels, beds for pickup trucks and the like.

U.S. Pat. No. 4,828,897 [Staneluis et al. (Staneluis)] teaches a high strength reinforced composite comprising an outer polymeric skin and an inner polymeric foam core chemically and mechanically bonded together at a high modulus, three dimensional interface. The interface comprises transverse or vertical orientation of fibers purportedly to improve compressive strength and to obviate delamination. Unfortunately, by orienting the fibers in this manner resistance to flexure is compromised.

There is an ongoing need for innovation in this area. Specifically, there is a need for alternate materials which have equal or improved strength properties, are relatively simple to produce, are relatively easy to finish (e.g., paint) and/or are lighter in weight than the products they are replacing. Further, it would be desirable to have an improved composite structure which provides a useful combination of resistance to flexure, compressive strength and resistance to delamination thereby improving the Staneluis composite.

### SUMMARY OF THE INVENTION

Accordingly, it is an object of the present invention to provide a novel composite structure which obviates or mitigates at least one of the above-identified disadvantages of the prior art.

It is another object of the present invention to provide a novel process for producing such a composite structure.

Accordingly, in one of its aspects, the present invention provides a composite structure comprising:
a core portion comprising a pair of generally opposed surfaces;
a first fibrous layer disposed on a first surface of the core portion, the first fibrous layer comprising a plurality of fibres disposed substantially parallel to the first surface;
a second fibrous layer disposed on a second surface of the core portion, the second fibrous layer comprising a plurality of fibres disposed substantially parallel to the second surface; and
a first polymer layer disposed over the first fibrous layer and a second polymer layer disposed over the second fibrous layer;

wherein: (i) the first fibrous layer is partially embedded in both the core portion and the first polymer layer, and (ii) the second fibrous layer is partially embedded in the core portion and the second polymer layer.

In another of its aspects, the present invention provides process for producing a composite structure in a mold comprising a first mold half having a first surface and a second mold half having a second surface, the first mold half and the second mold half engagable to define a mold cavity, the process comprising the steps of:
(i) placing a first polymer layer in the first mold half;
(ii) placing a second polymer layer in the second mold half;
(iii) partially embedding a first fibrous layer in the first polymer layer, the first fibrous layer comprising a plurality of fibres disposed substantially parallel to the first surface;
(iv) partially embedding a second fibrous layer in the second polymer layer, the second fibrous layer comprising a plurality of fibres disposed substantially parallel to the second surface;
(v) placing a core portion in the mold cavity;
(vi) closing the first mold half and the second mold half; and
(vii) partially embedding each of the first fibrous layer and the second fibrous layer in the core portion.

It is yet another object of the present invention to provide a process for producing a composite structure in a mold comprising a first mold half having a first surface and a second mold half having a second surface, the first mold half and the second mold half engagable to define a mold cavity, the process comprising the steps of:
(i) placing a first fibrous layer in the first mold half;
(ii) placing a second fibrous layer in the second mold half;
(iii) partially embedding the first fibrous layer and the second fibrous layer in a core portion to cause the first fibrous layer to be oriented substantially parallel to the first surface and the second fibrous layer to be oriented substantially parallel to the second surface;
(iv) placing the core portion in the a mold cavity;
(v) dispensing a first liquid polymeric composition between the first surface the first fibrous layer and a second liquid polymeric composition between the second surface the second fibrous layer; and
(vi) causing the first liquid polymeric composition to form a first polymer layer which is partially embedded in the first fibrous layer and the second liquid polymeric composition to form a second polymer layer which is partially embedded in the second fibrous layer.

Thus, the present inventors have surprisingly and unexpectedly discovered a novel composite structure having improved balance of compressive strength and flexural modulus, and having an integrated decorative surface (the polymers layers) that is ready for finishing. The present composite structure preferably comprises a generally planar surface. Within the structure, there is provided a core portion. Preferably, the core portion also comprises a pair of opposed generally planar surfaces. A pair of fibrous layers is disposed on each of the opposed, preferably generally planar, surfaces. Each fibrous layer comprises a plurality of fibres disposed substantially parallel to the plane of the fibrous layer. A pair of the polymer layers is disposed on each fibrous layer, respectively. These layers are arranged in a manner such that, for each fibrous layer, a portion thereof is embedded in the core portion and the polymer layer. Typically, this will occur in the interstices of the fibrous layer. Preferably, the core portion and the polymer layer will contact each other in the interstices in the fibrous layer. More preferably, the core portion and the polymer layer will be chemically bonded to one another in the interstices of the fibrous layer. By having the polymer layer and the core portion effectively each encapsulate a portion of the fibrous layer, a desirable balance of compressive strength, flexural modulus, impact resistance and resistance to delamination (i.e., improved inter-layer adhesion) is conferred to the composite structure.

The present composite structure will find utility in a wide variety of applications. For example, the present composite structure will find use in a number of automotive applications as an alternate material for structural and other components (resilient and non-resilient) of the vehicle. Such components include exterior body panels (e.g., TONNEAU covers), door panels, beds for pickup trucks and the like. Further, the present composite structure will find use in a number non-automotive applications such as marine, construction, personal protection devices (e.g., helmets) and the like.

### BRIEF DESCRIPTION OF THE DRAWINGS

Embodiments of the present invention will be described with reference to the accompanying drawings, wherein like numerals designate like elements, and in which:

FIG. 1 illustrates, in schematic, an initial step in the present process;

FIG. 2 illustrates a two-part mold useful to produce the present composite structure;

FIG. 3 illustrates an example of a fibrous layer useful in the present composite panel and process;

FIG. 4 illustrates an intermediate step in the present process;

FIG. 5 illustrates an enlarged section along line IV-IV in FIG. 4;

FIGS. 6-8 illustrate further steps in the present process; and

FIG. 9 illustrates an enlarged section along line VIII-VIII in FIG. 8.

### DETAILED DESCRIPTION OF THE PREFERRED EMBODIMENTS

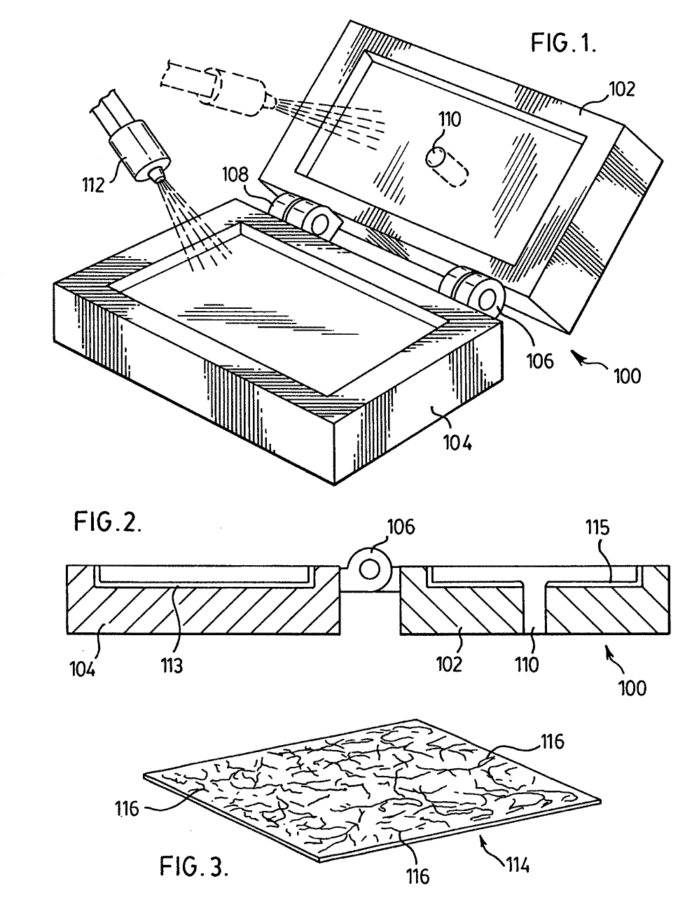

With reference to FIG. 1, there is illustrated a two-part mold 100 comprising an upper mold 102 and a lower mold 104. Upper mold 102 and lower mold 104 pivot about a pair of cooperating hinges 106,108. Upper mold 102 further comprises a port 110 whose function will described in more detail hereinbelow.

An initial step in the preferred embodiment of the present process involves spraying a liquid polymer composition (described below) on the interior surface of upper mold 102 to produce a polymer (elastomer) layer 115 and on lower mold 104 to produce a polymer (elastomer) layer 113. This step is accomplished using a conventional sprayer 112 which is moved between the lower mold 104 and the upper mold 102 (sprayer 112 is shown ghosted in the latter position).

With reference to FIG. 2, mold 100 is shown in a fully open state after the spraying step illustrated in FIG. 1.

In FIG. 3 there is illustrated a fibrous layer 114. Fibrous layer 114 comprises a plurality of fibres 116 which are aligned in a common plane of fibrous layer 114. As shown, substantially all of the plurality of fibres 116 are aligned in the common plane of fibrous layer 114 (i.e., there is little or no presence of fibres oriented out the common plane of fibrous layer 114).

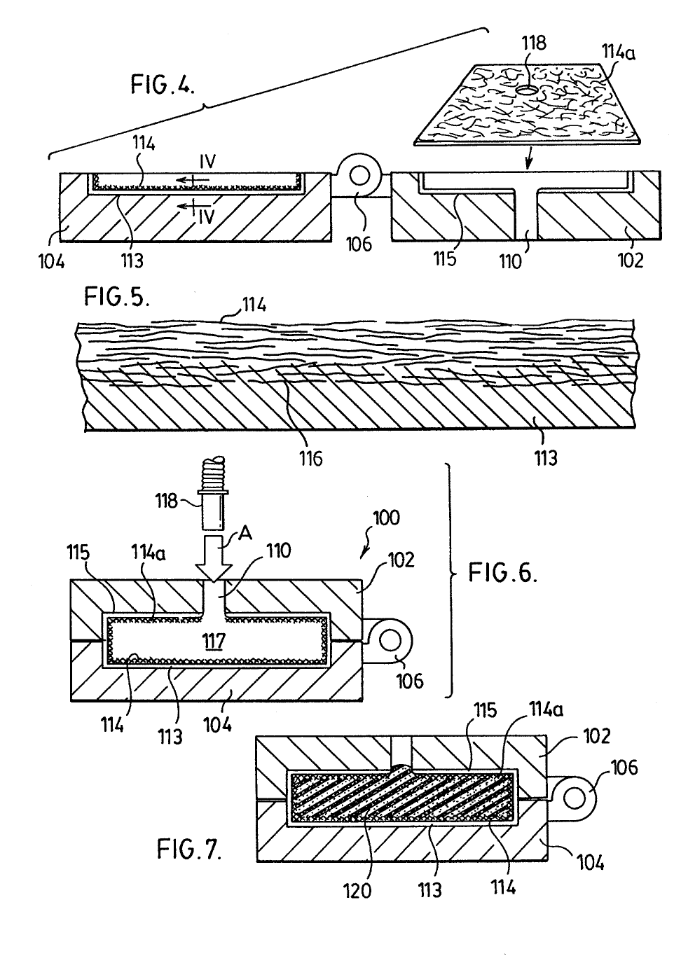

With reference to FIGS. 4 and 5, it will be seen that fibrous layer 114 is placed upper mold 104 and another fibrous layer 114a modified to have an aperture 118 is placed in upper mold 102 such that aperture 118 of fibrous layer 114a is in substantial alignment with port 110 in upper mold 102.

With reference to FIG. 5, fibrous layer 114 is placed in lower mold 104 in a manner such that at least a portion of fibres 116 of fibrous layer 114 are embedded in elastomer layer 113. Thus, it is preferred to conduct the step illustrated in FIG. 4 prior to complete curing of polymer layer 113. While not specifically illustrated, fibrous layer 114a is placed in upper mold 102 to have a similar embedding of individual fibres with polymer layer 115 in upper mold 102.

With reference to FIG. 6, mold 100 is shown in a closed state, namely mold 102 is swung about hinges 106,108 so that is closed with respect to lower mold 104 to define a mold cavity 117.

Next, a dispenser 118 is generally aligned with port 110 of upper mold 102. A foamable composition is then dispensed from dispenser 118 in the direction of arrow A such that the foamable composition enters mold cavity 117 via port 102. The foamable composition expands to fill mold cavity 117 to define a foam core portion 120.

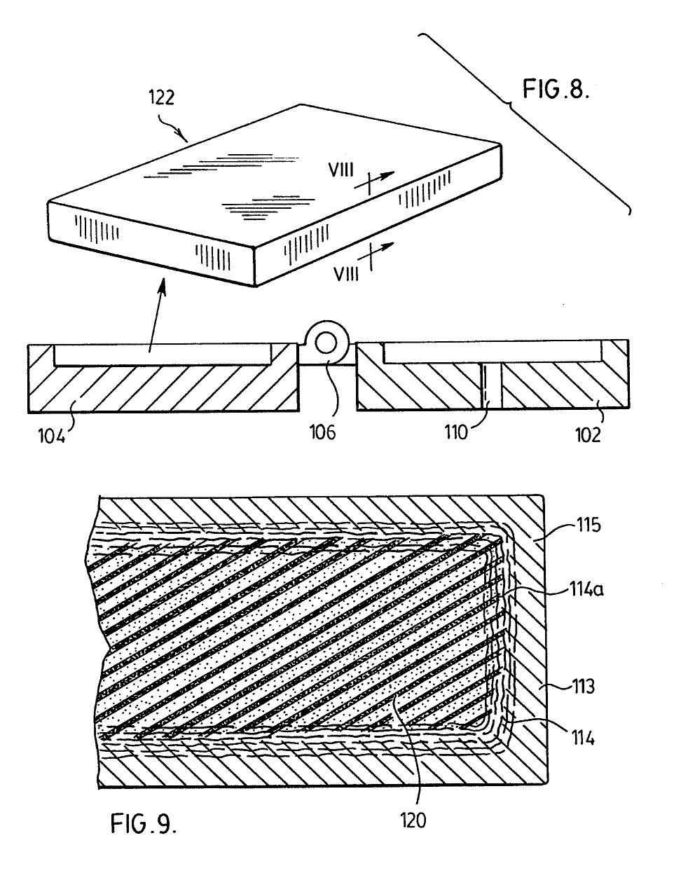

With reference to FIG. 8, upper mold 102 and lower mold 104 are opened and a finished composite structure 122 is demolded therefrom.

With reference to FIG. 9, it can be seen that foam core portion 120 of composition 122 is partially embedded into fibrous layers 114,114a. Further, elastomeric layers 113,115 are similarly partially embedded in fibrous layers 114a,114, respectively. Further, a chemical bond is formed at the interface of foam core portion 120 and elastomeric layers 113,115. This chemical bond confers enhanced strength to composite structure 122 without the need to have transverse alignment of individual fibres with respect to a planar orientation of the fibrous layer.

Preferably, the core portion of the composite comprises a cellular material such as a foam. Alternatively, the core portion of the present composite may comprise a porous material such as gel-blown horsehair and the like. It is also possible to utilize non-cellular materials such as wood, polymers, metal, paper products, SRIM products and the like. When non-cellular materials are used in as the core portion, it may be desirable to dispose an adhesive, a polymerizable composition (e.g., like the one used to produces polymer layers 113,115 described and the like), etc. to provide a supplementary layer which would be received by and partially embedded in the fibrous layers.

The preferred foam for use in the core portion of the present composite is a foamed isocyanate-based polymer. Preferably, the isocyanate-based polymer is selected from the group comprising polyurethane, polyurea, polyisocyanurate, urea-modified polyurethane, urethane-modified polyurea, urethane-modified polyisocyanurate and urea-modified polyisocyanurate. As is known in the art, the term “modified”, when used in conjunction with a polyurethane, polyurea or polyisocyanurate means that up to 50% of the polymer backbone forming linkages have been substituted.

Typically, the foamed isocyanate-based polymer is produced from a reaction mixture which comprises an isocyanate and an active hydrogen-containing compound.

The isocyanate suitable for use in the reaction mixture is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g., an alkylene or arylene group). Moreover, Q may be represented by the general formula:

Q¹-Z-Q¹

wherein Q¹ is an alkylene or arylene group and Z is chosen from the group comprising —O—, —O-Q¹-, —CO—, —S—, —S-Q¹-S— and —SO₂—. Examples of isocyanate compounds which fall within the scope of this definition include hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4′-diisocyanate, naphthalene-1,5-diisocyanate, triphenylmethane-4,4′,4″-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as defined hereinabove) with an active hydrogen-containing compound (as defined hereinafter), preferably the polyhydroxyl-containing materials or polyols described below. In this embodiment, the polyisocyanate may be, for example, used in proportions of from about 30 percent to about 200 percent stoichiometric excess with respect to the proportion of hydroxyl in the polyol. Since the process of the present invention may relate to the production of polyurea foams, it will be appreciated that in this embodiment, the prepolymer could be used to prepare a polyurethane modified polyurea.

In another embodiment, the isocyanate compound suitable for use in the process of the present invention may be selected from dimers and trimers of isocyanates and diisocyanates, and from polymeric diisocyanates having the general formula:

[Q′(NCO)ᵢ]ⱼ

wherein both i and j are integers having a value of 2 or more, and Q′ is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also for example, British patent No. 1,453,258, for a discussion of suitable isocyanates.

Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof. A more preferred isocyanate is selected from the group comprising 2,4-toluene diisocyanate, 2,6-toluene diisocyanate and mixtures thereof, for example, a mixture comprising from about 75 to about 85 percent by weight 2,4-toluene diisocyanate and from about 15 to about 25 percent by weight 2,6-toluene diisocyanate. Another more preferred isocyanate is selected from the group comprising 2,4′-diphenylmethane diisocyanate, 4,4′-diphenylmethane diisocyanate and mixtures thereof The most preferred isocyanate is a mixture comprising from about 15 to about 25 percent by weight 2,4′-diphenylmethane diisocyanate and from about 75 to about 85 percent by weight 4,4′-diphenylmethane diisocyanate.

If the process is utilized to produce a polyurethane foam, the active hydrogen-containing compound is typically a polyol. The choice of polyol is not particularly restricted and is within the purview of a person skilled in the art. For example, the polyol may be a hydroxyl-terminated backbone of a member selected from the group comprising polyether, polyester, polycarbonate, polydiene and polycaprolactone. Preferably, the polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyols are selected from the group comprising adipic acid-ethylene glycol polyester, poly(butylene glycol), poly(propylene glycol) and hydroxyl-terminated polybutadiene—see, for example, British patent No. 1,482,213, for a discussion of suitable polyols. Preferably, such a polyether polyol has a molecular weight in the range of from about 200 to about 10,000, more preferably from about 2,000 to about 7,000, most preferably from about 2,000 to about 6,000.

If the core portion is to comprise a polyurea foam, the active hydrogen-containing compound comprises compounds wherein hydrogen is bonded to nitrogen. Preferably such compounds are selected from the group comprising polyamines, polyamides, polyimines and polyolamines, more preferably polyamines. Non-limiting examples of such compounds include primary and secondary amine terminated polyethers. Preferably such polyethers have a molecular weight of greater than about 230 and a functionality of from 2 to 6. Such amine terminated polyethers are typically made from an appropriate initiator to which a lower alkylene oxide is added with the resulting hydroxyl terminated polyol being subsequently aminated. If two or more alkylene oxides are used, they may be present either as random mixtures or as blocks of one or the other polyether. For ease of amination, it is especially preferred that the hydroxyl groups of the polyol be essentially all secondary hydroxyl groups. Typically, the amination step replaces the majority but not all of the hydroxyl groups of the polyol.

The reaction mixture used to produce the foamed isocyanate-based polymer core portion typically will further comprise a blowing agent. As is known in the art, water can be used as an indirect or reactive blowing agent in the production of foamed isocyanate-based polymers. Specifically, water reacts with the isocyanate forming carbon dioxide which acts as the effective blowing agent in the final foamed polymer product. Alternatively, the carbon dioxide may be produced by other means such as unstable compounds which yield carbon dioxide (e.g., carbamates and the like). Optionally, direct organic blowing agents may be used in conjunction with water although the use of such blowing agents is generally being curtailed for environmental considerations. The preferred blowing agent for use in the production of the present foamed isocyanate-based polymer comprises water.

It is known in the art that the amount of water used as an indirect blowing agent in the preparation of a foamed isocyanate-based polymer is conventionally in the range of from about 0.5 to as high as about 40 or more parts by weight, preferably from about 1.0 to about 10 parts by weight, based on 100 parts by weight of the total active hydrogen-containing compound content in the reaction mixture. As is known in the art, the amount of water used in the production of a foamed isocyanate-based polymer typically is limited by the fixed properties expected in the foamed polymer and by the tolerance of the expanding foam towards self structure formation.

To produce the core portion made from a foamed isocyanate-based polymer, a catalyst is usually incorporated in the reaction mixture. The catalyst used in the reaction mixture is a compound capable of catalyzing the polymerization reaction. Such catalysts are known, and the choice and concentration thereof in the reaction mixture is within the purview of a person skilled in the art. See, for example, U.S. Pat. Nos. 4,296,213 and 4,518,778 for a discussion of suitable catalyst compounds. Non-limiting examples of suitable catalysts include tertiary amines and/or organometallic compounds. Additionally, as is known in the art, when the objective is to produce an isocyanurate, a Lewis acid must be used as the catalyst, either alone or in conjunction with other catalysts. Of course it will be understood by those skilled in the art that a combination of two or more catalysts may be suitably used.

The present composite further comprises a first fibrous layer and a second fibrous layer disposed on opposed surfaces of the core portion. These two layers may be the same or different. Preferably, the a first fibrous layer and a second fibrous layer are the same. Non-limiting examples of fibrous layers useful in the present composite may be selected from the group comprising glass fibres (e.g., in the form of a cloth or a mat, chopped or unchopped, such as Nico 754 1 oz/ft²), polyester fibres, polyolefin fibres (e.g., polyethylene and polypropylene), Kevlar™ fibres, polyamides fibres (e.g. nylon), cellulose fibres (e.g., burlap), carbon fibres, cloth materials such spun bound polyesters (e.g., Lutravil™ 1DH7210B/LDVT222 and Freudenberg™ PTLD585G/PTLD600B) and paper (e.g., Kraft #60). It will be appreciated that the fibrous layer may be woven or non-woven.

The preferred fibrous layer for use in the present composite comprises 10 oz. 0-90 woven S-glass™ fibrous mat commercially available from Owens Corning.

As described above, a pair of the polymer layers is disposed on each fibrous layer, respectively. These layers are arranged in a manner such that, for each fibrous layer, a portion thereof is embedded in the core portion and the polymer layer. Typically, this will occur in the interstices of the fibrous layer. Preferably, the core portion and the polymer layer will contact each other in the interstices in the fibrous layer. More preferably, the core portion and the polymer layer will be chemically bonded to one another in the interstices of the fibrous layer. By having the polymer layer and the core portion effectively each encapsulate a portion of the fibrous layer, a desirable balance of compressive strength, flexural modulus and impact resistance is conferred to the composite structure.

Preferably, each of the polymer layers comprises an elastomer layer. The elastomer layer may be used in the form of a sheet, a film or the like. Non-limiting examples of suitable thermoplastic elastomer layers may be selected from the group comprising polyacrylate, polyvinylflouride, polycarbonate, acrylic ester modified styrene acrylonitrile terpolymer (ASA), AES, acrylonitrile-butadiene-styrene terpolymer (ABS) and the like.

Thermoplastics are materials which soften and flow upon the application of heat. Upon cooling, the thermoplastic will be substantially chemically unchanged and my assume a different physical shape. With reference to the specific embodiment of the present process described above, it is possible to modify the specific process to take advantage of this feature of thermoplastic materials. Thus, integration and embedding of each fibrous layer into the thermoplastic exterior layer is achievable the heating of the inner-surface of the thermoplastic beyond the melt temperature and thereafter pressing the fibrous layer into the heat surface of the thermoplastic exterior layer. Flame lamination is one such method. In flame lamination, a flame is applied to one contact point of the thermoplastic, with the fibrous layer being applied in close proximity and pressure. The fibrous layer in held-in-place upon cooling. The a pair of the resulting laminates of thermoplastic material and fibrous layer may then be placed in the mold described above followed by subsequent production of the foam core. Preferably, the foam core will then be embedded in each fibrous layer and contacts the exterior thermoplastic layer.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A composite structure comprising:
a core portion having a pair of generally opposed surfaces;
a first fibrous layer disposed on a first surface of the core portion, the first fibrous layer comprising a plurality of fibres disposed substantially parallel to the first surface;
a second fibrous layer disposed oh a second surface of the core portion, the second fibrous layer comprising a plurality of fibres disposed substantially parallel to the second surface; and
a first polymer layer disposed over the first fibrous layer and a second polymer layer disposed over the second fibrous layer;
wherein: (i) the first fibrous layer is partially embedded in both the core portion and the first polymer layer, and (ii) the second fibrous layer is partially embedded in the core portion and the second polymer layer.

2. The composite structure defined in claim 1, wherein the first polymer layer and the first surface of the core portion are in contact with one another.

3. The composite structure defined in claim 1, wherein the second polymer layer and the second surface of the core portion are in contact with one another.

4. The composite structure defined in claim 1, wherein the first polymer layer and the first surface of the core portion are in contact with one another, and the second polymer layer and the second surface of the core portion are in contact with one another.

5. The composite structure defined in claim 1, wherein the first polymer layer and the first surface of the core portion are chemically bonded to one another.

6. The composite structure defined in claim 1, wherein the second polymer layer and the second surface of the core portion are chemically bonded to one another.

7. The composite structure defined in claim 1, wherein the first polymer layer and the first surface of the core portion are chemically bonded to one another, and the second polymer layer and the second surface of the core portion are chemically bonded to one another.

8. The composite structure defined in claim 1, wherein the first surface and the second surface are substantially parallel to one another.

9. The composite structure defined in claim 1, wherein the first polymer coating and the second polymer coating combine to substantially completely cover the composite structure.

10. The composite structure defined in claim 1, wherein the core portion comprises a cellular material.

11. The composite structure defined in claim 1, wherein the core portion comprises a polymer foam.

12. The composite structure defined in claim 1, wherein the core portion comprises an isocyanate-based polymer foam.

13. The composite structure defined in claim 1, wherein the core portion comprises a polyurethane foam.

14. The composite structure defined in claim 1, wherein the core portion comprises a molded polyurethane foam.

15. The composite structure defined in claim 1, wherein the core portion comprises a non-cellular material.

16. The composite structure defined in claim 1, wherein the first fibrous layer and the second fibrous layer are the same.

17. The composite structure defined in claim 1, wherein the first fibrous layer and the second fibrous layer are different.

18. The composite structure defined in claim 1, wherein one or both of the first fibrous layer and the second fibrous layer are woven.

19. The composite structure defined in claim 1, wherein one or both of the first fibrous layer and the second fibrous layer are non-woven.

20. The composite structure defined in claim 1, wherein each of the first fibrous layer and the second fibrous layer contains at least one member selected from the group comprising glass fibres, polyester fibres, polyolefin fibres, Kevlar™ fibres, polyamide fibres, cellulose fibres, carbon fibres and mixtures thereof.

21. The composite structure defined in claim 1, wherein each of the first fibrous layer and the second fibrous layer comprises a fibreglass mat.

22. The composite structure defined in claim 1, wherein each of the first fibrous layer and the second fibrous layer comprises at least one member selected from the group comprising spun bound polyesters and paper.

23. The composite structure defined in claim 1, wherein the first polymer layer and the second polymer layer are the same.

24. The composite structure defined in claim 1, wherein the first polymer layer and the second polymer layer are different.

25. The composite structure defined in claim 1, wherein the first polymer layer and the second polymer layer are non-cellular.

26. The composite structure defined in claim 1, wherein the first polymer layer and the second polymer layer each comprise an isocyanate-based polymer.

27. The composite structure defined in claim 1, wherein the first polymer layer and the second polymer layer each comprise polyurea.

28. The composite structure defined in claim 1, wherein the first polymer layer and the second polymer layer each comprise polyurethane.

29. A vehicular body panel comprising the composite structure defined in claim 1.

30. A vehicular door panel comprising the composite structure defined in claim 1.

31. A vehicular flat bed panel comprising the composite structure defined in claim 1.

32. A process for producing a composite structure in a mold comprising a first mold half having a first surface and a second mold half having a second surface, the first mold half and the second mold half engagable to define a mold cavity, the process comprising the steps of:
(i) placing a first polymer layer in the first mold half;
(ii) placing a second polymer layer in the second mold half;
(iii) partially embedding a first fibrous layer in the first polymer layer, the first fibrous layer comprising a plurality of fibres disposed substantially parallel to the first surface;
(iv) partially embedding a second fibrous layer in the second polymer layer, the second fibrous layer comprising a plurality of fibres disposed substantially parallel to the second surface;
(v) placing a core portion in the mold cavity;
(vi) closing the first mold half and the second mold half; and
(vii) partially embedding each of the first fibrous layer and the second fibrous layer in the core portion.

33. The process defined in claim 32, wherein Step (v) comprises dispensing a liquid polymeric composition on a portion of a surface of one of the first mold half and the second mold half.

34. The process defined in claim 32, wherein Step (v) comprises dispensing a liquid foamable polymeric composition on a portion of a surface of one of the first mold half and the second mold half.

35. The process defined in claim 32, wherein Step (v) comprises dispensing a liquid foamable isocyanate-based polymeric composition on a portion of a surface of one of the first mold half and the second mold half.

36. The process defined in claim 32, wherein Step (vi) is conducted after Step (v).

37. The process defined in claim 32, wherein Step (v) is conducted after Step (vi).

38. The process defined in claim 32 wherein the first fibrous layer and the second fibrous layer are the same.

39. The process defined in claim 32, wherein the first fibrous layer and the second fibrous layer are different.

40. The process defined in claim 32, wherein one or both of the first fibrous layer and the second fibrous layer are woven.

41. The process defined in claim 32, wherein one or both of the first fibrous layer and the second fibrous layer are non-woven.

42. The process defined in claim 32, wherein each of the first fibrous layer and the second fibrous layer contains at least one member selected from the group comprising glass fibres, polyester fibres, polyolefin fibres, Kevlar™ fibres, polyamide fibres, cellulose fibres, carbon fibres and mixtures thereof.

43. The process defined in claim 32, wherein each of the first fibrous layer and the second fibrous layer comprises a fibreglass mat.

44. The process defined in claim 32, wherein each of the first fibrous layer and the second fibrous layer comprises at least one member selected from the group comprising spun bound polyesters and paper.

45. The process defined in claim 32, wherein Step (i) comprises spraying a liquid material to substantially cover the first surface.

46. The process defined in claim 32, wherein Step (i) comprises spraying a liquid polymeric material to substantially cover the first surface.

47. The process defined in claim 32, wherein Step (i) comprises spraying a liquid polymeric reactive material to substantially cover the first surface.

48. The process defined in claim 32, wherein Step (i) comprises spraying a liquid isocyanate-based polymer reactive material to substantially cover the first surface.

49. The process defined in claim 32, wherein Step (ii) comprises spraying a liquid material to substantially cover the second surface.

50. The process defined in claim 32, wherein Step (ii) comprises spraying a liquid polymeric material to substantially cover the second surface.

51. The process defined in claim 32, wherein Step (ii) comprises spraying a liquid polymeric reactive material to substantially cover the second surface.

52. The process defined in claim 32, wherein Step (ii) comprises spraying a liquid isocyanate-based polymer reactive material to substantially cover the second surface.

53. A process for producing a composite structure in a mold comprising a first mold half having a first surface and a second mold half having a second surface, the first mold half and the second mold half engagable to define a mold cavity, the process comprising the steps of:
(i) placing a first fibrous layer in the first mold half;
(ii) placing a second fibrous layer in the second mold half;
(iii) partially embedding the first fibrous layer and the second fibrous layer in a core portion to cause the first fibrous layer to be oriented substantially parallel to the first surface and the second fibrous layer to be oriented substantially parallel to the second surface;
(iv) placing the core portion in the a mold cavity;
(v) dispensing a first liquid polymeric composition between the first surface the first fibrous layer and a second liquid polymeric composition between the second surface the second fibrous layer; and
(vi) causing the first liquid polymeric composition to form a first polymer layer which is partially embedded in the first fibrous layer and the second liquid polymeric composition to form a second polymer layer which is partially embedded in the second fibrous layer.

54. The process in claim 53, wherein Step (v) comprises injecting a liquid material to substantially encapsulates the core portion.

55. The process in claim 53, wherein Step (v) comprises injecting a liquid polymeric material to substantially encapsulates the core portion.

56. The process in claim 53, wherein Step (v) comprises injecting a liquid polymeric reactive material to substantially encapsulates the core portion.

57. The process in claim 53, wherein Step (v) comprises injecting a liquid isocyanate-based polymer reactive material to substantially encapsulate the core portion.
